(19) United States
(12) Patent Application Publication
(10) Pub. No.: US 2010/0318723 A1
(43) Pub. Date: Dec. 16, 2010

(54) MEMORY CONTROLLER, NONVOLATILE MEMORY DEVICE, AND NONVOLATILE MEMORY SYSTEM

(76) Inventors: Masahiro Nakanishi, Kyoto (JP); Tetsushi Kasahara, Osaka (JP); Takefumi Sugai, Miyagi (JP); Hironori Mori, Miyagi (JP); Kunihiro Maki, Osaka (JP); Kazuaki Tamura, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/526,089

(22) PCT Filed: Jan. 29, 2008
(86) PCT No.: PCT/JP2008/051256

§ 371 Date: Aug. 6, 2009

(30) Foreign Application Priority Data
Feb. 23, 2007 (JP) 2007-043495

(51) Int. Cl. G06F 12/00; G06F 12/02

(52) U.S. Cl. 711/103; 711/165; 711/E12.001; 711/E12.008

(57) ABSTRACT

A nonvolatile memory device includes a plurality of memory controllers. Each of the memory controllers has an aggregation processing part and an aggregation synchronization part. Based on a signal from the aggregation synchronization part, the aggregation processing part aggregates valid data of a temporary physical block into another physical block. When one of the memory controllers requires an aggregation process, the aggregation synchronization part sends a synchronization signal to the other memory controller, so that the aggregation process is simultaneously carried out by the other memory controller. Thus, in the nonvolatile memory device having a plurality of memory controllers, it is possible to reduce the time required for the aggregation process and carry out a high-speed writing process.

### TECHNICAL FIELD

The present invention relates to a nonvolatile memory device such as a semiconductor memory card having a nonvolatile memory, a controller for controlling the nonvolatile memory, and a nonvolatile memory system configured by adding an access device as a component to the nonvolatile memory device.

### BACKGROUND ART

A nonvolatile memory device having a rewritable nonvolatile memory is increasingly demanded mainly for a semiconductor memory card. The semiconductor memory card is high-price compared to an optical disk, a tape medium, and the like, however, the semiconductor memory card is increasingly demanded as a memory medium for a portable apparatus such as a digital still camera and a mobile phone because of merits such as small-size, lightweight, vibration resistance, and easy handling. In these years, the semiconductor memory card is used as a memory medium of a consumer-use moving image recording apparatus and a professional-use moving image recording apparatus. In addition, not only the portable apparatus but also a digital television, a DVD recorder, and like include a slot for the semiconductor memory as standard equipment, and thus still images shot with the digital still camera can be browsed on the digital television and a moving image shot by the consumer-use moving image recording apparatus can be dubbed to a DVD recorder.

The nonvolatile memory device such as the semiconductor memory card includes a flash memory as a nonvolatile main memory, and has a memory controller for controlling it. The memory controller controls data reading and data writing to the flash memory in accordance with reading and writing commands from an access device such as a digital still camera.

Meanwhile, the nonvolatile memory device can be divided broadly into 2 types, a low-cost device with a low writing speed (hereinafter referred to as a type S) and a high-cost device with a high writing speed (hereinafter referred to as a type M). The type S is mainly used for a system such as a personal computer allowing relatively-low speed access, and the type M is mainly used for a system such as a moving image recording and reproducing device requiring high speed access.

The type S nonvolatile memory device mounts a flash memory of one chip, and further mounts a single bus controller of one chip (hereinafter referred to as a controller 1) for accessing the flash memory via a memory bus as a memory controller for an access control of this flash memory. On the other hand, the type M nonvolatile memory device mounts flash memories of two chips or more, further mounts a multi bus controller (hereinafter referred to as a controller 2), and independently connects the flash memories to each bus of the controller 2.

However, when different memory controllers exclusively for the type S and the type M are developed, respectively, there is a problem that requires a large development cost of the memory controller.

Regarding this problem, Patent document 1 proposes a device using a universal memory controller regardless of the types. This device includes three types of circuit parts: a universal controller called a block controller; an interface with an access device such as a camera; and a master controller for controlling whole of the block controller, and mounts one block controller when realizing the type S or mounts a plurality of block controllers when realizing the type M.

Patent document 1: Japanese Unexamined Patent Publication No. H04-268284

### DISCLOSURE OF THE INVENTION

### Problems to be Solved by the Invention

However, even when realizing a simultaneous access to a plurality of flash memories, the above-mentioned conventional nonvolatile memory device has a problem that constricts a speeding-up because an aggregation process has to be carried out to each flash memory.

In view of the above-mentioned problem, the present invention intends to provide a memory controller, a nonvolatile memory device, and a nonvolatile memory system which are able to carry out a high-speed writing process.

### Means to Solve the Problems

To solve the problem, a memory controller of the present invention which writes data to a nonvolatile memory having a plurality of physical blocks as a recording area and reads data from said nonvolatile memory, comprises: a reading-writing control part for carrying out data writing and data reading processes to said nonvolatile memory in accordance with a signal from an outside device; an aggregation synchronization part for ordering starting an aggregation process when all free regions of a temporary physical block to which transferred data is temporarily written have run out or when a synchronization signal is inputted from the outside device, and for outputting a synchronization signal when all free regions of said temporary physical block have run out; and an aggregation processing part for aggregating valid data of said temporary physical block to another physical block on the basis of a signal from said aggregation synchronization part.

The memory controller may further comprise: a mode detection part for determining based on an identification signal inputted from the outside device whether the memory controller is activated in a single mode or in a dual mode.

The memory controller may further comprise: a master-slave detection part for determining based on an identification signal inputted from the outside device whether the memory controller is used as a master memory controller or a slave memory controller.

The memory controller may further comprise: a mode detection part for determining based on an identification signal inputted from the outside device whether the memory controller is activated in a single mode or in a dual mode; and a master-slave detection part for determining based on the identification signal inputted from the outside device whether the memory controller is used as a master memory controller or a slave memory controller.

To solve the problem, a memory controller of the present invention comprises: a reading-writing control part for carrying out data writing and data reading processes to said nonvolatile memory in accordance with a signal from an outside device; an aggregation synchronization part for ordering starting an aggregation process when a free capacity of a temporary physical block have fallen below a predetermined threshold value or when a synchronization signal is inputted from the outside device, and for outputting a synchronization signal when a free capacity of said temporary physical block have fallen below the predetermined threshold value; and an aggregation processing part for aggregating valid data of said temporary physical block to another physical block on the basis of a signal from said aggregation synchronization part.

To solve the problem, a nonvolatile memory device of the present invention has a plurality of memory modules, wherein said each memory module includes: a nonvolatile memory having a plurality of physical blocks as a recording area; and a memory controller for writing data to said nonvolatile memory and reading data from said nonvolatile memory, and said memory controller includes: a reading-writing control part for carrying out data writing and data reading processes to said nonvolatile memory in accordance with a signal from an outside device; an aggregation synchronization part for ordering starting an aggregation process when all free regions of a temporary physical block to which transferred data is temporarily written have run out or when a synchronization signal is inputted from a memory controller of another memory module, and for outputting a synchronization signal when all free regions of said temporary physical block have run out; and an aggregation processing part for aggregating valid data of said temporary physical block to another physical block on the basis of a signal from said aggregation synchronization part.

Said each memory controller may further include: a mode detection part for determining based on an identification signal inputted from the outside device whether the memory controller is activated in a single mode or in a dual mode.

Said each memory controller may further include: a master-slave detection part for determining based on an identification signal inputted from the outside device whether the each memory controller is used as a master memory controller or a slave memory controller.

Based on a signal from a master-slave detection part of one memory module, said master-slave detection part may use other memory controller as the master memory controller or the slave memory controller.

Said each memory controller may further include: a mode detection part for determining based on an identification signal inputted from the outside device whether the each memory controller is activated in a single mode or in a dual mode; and a master-slave detection part for determining based on the identification signal inputted from the outside device whether the each memory controller is used as a master memory controller or a slave memory controller.

Based on a signal from a master-slave detection part of one memory module, said master-slave detection part may use other memory controller as the master memory controller or the slave memory controller.

To solve the problem, a nonvolatile memory device of the present invention has a plurality of memory modules, wherein said each memory module includes: a nonvolatile memory having a plurality of physical blocks as a recording area; and a memory controller for writing data to said nonvolatile memory and reading data from said nonvolatile memory, and said memory controller includes: a reading-writing control part for carrying out data writing and data reading processes to said nonvolatile memory in accordance with a signal from an outside device; an aggregation synchronization part for ordering starting an aggregation process when a free capacity of a temporary physical block have fallen below a predetermined threshold value or when a synchronization signal is inputted from a memory controller of another memory module, and for outputting a synchronization signal when a free capacity of said temporary physical block have fallen below the predetermined threshold value; and an aggregation processing part for aggregating valid data of said temporary physical block to another physical block on the basis of a signal from said aggregation synchronization part.

To solve the problem, a nonvolatile memory system of the present invention comprises: a nonvolatile memory device having a plurality of memory modules; and an access device for accessing said nonvolatile memory device, wherein each memory module is said nonvolatile memory device includes: a nonvolatile memory having a plurality of physical blocks as a recording area; and a memory controller for writing data to said nonvolatile memory and reading data from said nonvolatile memory, and said memory controller includes: a reading-writing control part for carrying out data writing and data reading processes to said nonvolatile memory in accordance with a signal from an outside device; an aggregation synchronization part for ordering starting an aggregation process when all free regions of a temporary physical block to which transferred data is temporarily written have run out or when a synchronization signal is inputted from a memory controller of another memory module, and for outputting a synchronization signal when all free regions of said temporary physical block have run out; and an aggregation processing part for aggregating valid data of said temporary physical block to another physical block on the basis of a signal from said aggregation synchronization part.

Said each memory controller may further include: a mode detection part for determining based on an identification signal inputted from the outside device whether the memory controller is activated in a single mode or in a dual mode.

Said each memory controller may further include: a master-slave detection part for determining based on an identification signal inputted from the outside device whether the each memory controller is used as a master memory controller or a slave memory controller.

Based on a signal from a master-slave detection part of one memory module, said master-slave detection part may use other memory controller as the master memory controller or the slave memory controller.

Said each memory controller may further include: a mode detection part for determining based on an identification signal inputted from the outside device whether the each memory controller is activated in a single mode or in a dual mode; and a master-slave detection part for determining based on the identification signal inputted from the outside device whether the each memory controller is used as a master memory controller or a slave memory controller.

Based on a signal from a master-slave detection part of one memory module, said master-slave detection part may use other memory controller as the master memory controller or the slave memory controller.

To solve the problem, a nonvolatile memory system of the present invention comprises: a nonvolatile memory device having a plurality of memory modules; and an access device for accessing said nonvolatile memory device, wherein each memory module is said nonvolatile memory device includes: a nonvolatile memory having a plurality of physical blocks as a recording area; and a memory controller for writing data to said nonvolatile memory and reading data from said nonvolatile memory, and said memory controller includes: a reading-writing control part for carrying out data writing and data reading processes to said nonvolatile memory in accordance with a signal from an outside device; an aggregation synchronization part for ordering starting an aggregation process when a free capacity of a temporary physical block have fallen below a predetermined threshold value or when a synchronization signal is inputted from a memory controller of another memory module, and for outputting a synchronization signal when a free capacity of said temporary physical block have fallen below the predetermined threshold value; and an aggregation processing part for aggregating valid data of said temporary physical block to another physical block on the basis of a signal from said aggregation synchronization part.

Said identification signal may be a voltage level that changes on the basis of a power supply voltage supplied to said each memory controller.

### EFFECTIVENESS OF THE INVENTION

In the present invention, a memory controller is able to synchronously carry out an aggregation process to a nonvolatile memory. Accordingly, in a case of realizing a nonvolatile memory device able to access a plurality of nonvolatile memories, processing times required for the aggregation processes of the memory controllers can be covered up each other, and accordingly an overall writing speed of the nonvolatile memory system can be increased.

In addition, according to the present invention, by comprising a plurality of memory modules including a nonvolatile memory and memory controller, and further including a detection part in each memory module, the respective memory controllers can be activated as a master controller or a slave controller. Moreover, the present invention can realize a low-cost nonvolatile memory system because the memory controller is shared.

### BRIEF DESCRIPTION OF DRAWINGS

FIG. 1 is a block diagram of a nonvolatile memory system according to Embodiment 1 of the present invention.

FIG. 2A is a block diagram showing a major portion of a memory controller according to the embodiment.

FIG. 2B is a block diagram showing a major portion of a memory controller according to the embodiment.

FIG. 3 is a flowchart showing an initialization process of a memory controller 110.

FIG. 4 is a flowchart showing an initialization process of a memory controller 140.

FIG. 5A is a view showing a writing process in a single mode.

FIG. 5B is a view showing a writing process in a dual mode.

FIG. 6A is a view showing a format of logical address LA in the single mode.

FIG. 6B is a view showing a format of logical address LA in the dual mode.

FIG. 7 is a view showing a writing state according to the embodiment of the present invention before an aggregation synchronization.

FIG. 8 is a view showing a writing process according to the embodiment of the present invention of a case where the aggregation synchronization is carried out.

FIG. 9 is a time chart showing the writing process according to the embodiment of the present invention of a case where the aggregation synchronization is carried out.

FIG. 10 is a block diagram of a nonvolatile memory system according to a comparative example.

FIG. 11A is a block diagram showing a major portion of a memory controller according to the comparative example.

FIG. 11B is a block diagram showing a major portion of a memory controller according to the comparative example.

FIG. 12 is a view showing a writing state according to the comparative example of a case where one of the controller carries out the aggregation synchronization.

FIG. 13 is a view showing a writing state according to the comparative example of a case where the other controller carries out the aggregation synchronization.

FIG. 14 is a time chart showing the writing process according to the comparative example of a case where the aggregation synchronization is carried out.

### EXPLANATION FOR REFERENCE NUMERALS

100 Access device
101, 201 Nonvolatile memory device
103, 104, 203, 204 Memory module
105 External bus
110, 140, 210, 240 Memory controller
111, 141 Front-end part
112, 142 Core control part
113, 143, 213, 243 Back-end part
114, 144 Mode detection part
115, 145 MS detection part
116, 146 A1 port
117, 147 A2 port
118, 148 B port
119, 149 C port
120, 150 Host interface part
121, 151 Buffer memory
122, 152 CPU
123, 153 RAM
124, 154 ROM
125, 155, 225, 255 Address management part
126, 156 Reading-writing control part
130, 160 Nonvolatile memory
131, 132, 133, 161, 162, 163 Physical block
127, 157 Aggregation processing part
128, 158 Aggregation synchronization part

### BEST MODE FOR CARRYING OUT THE INVENTION

### Embodiment

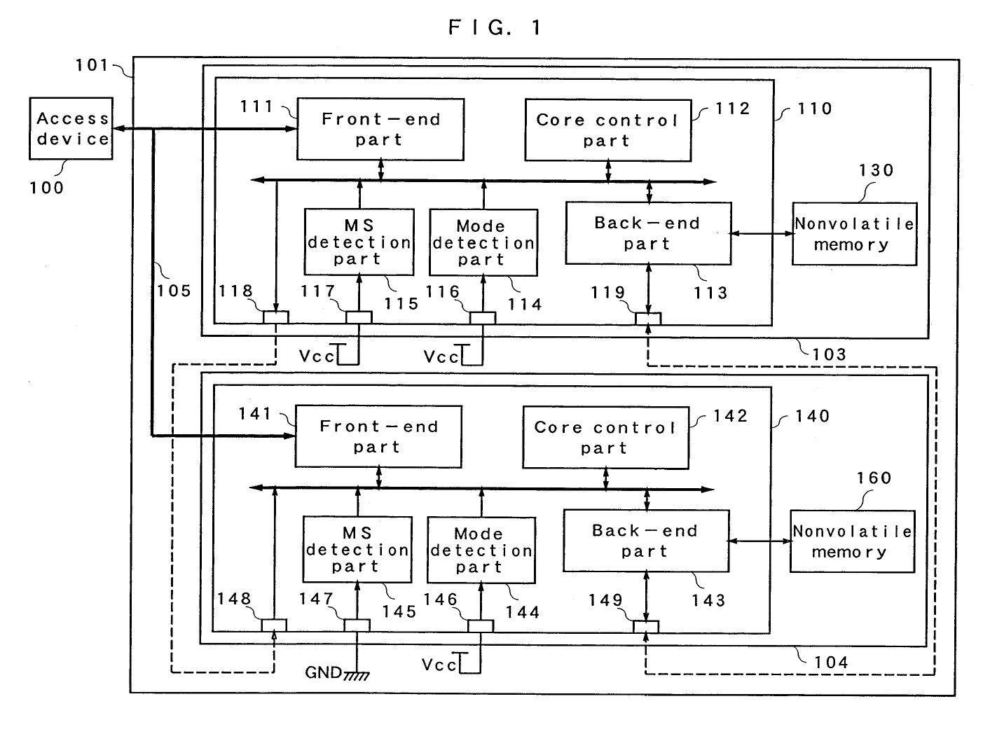

Referring to drawings, a nonvolatile memory system according to an embodiment of the present invention will be concretely explained below, including a comparative example. FIG. 1 is a block diagram of the nonvolatile memory system according to the embodiment of the present invention. The nonvolatile memory system includes an access device 100 and a nonvolatile memory device 101 connected to the access device 100. The nonvolatile memory device 101 includes: two memory modules 103 and 104 mounted on a substrate; and an external bus 105 for transferring data with the access device 100.

The memory module 103 includes a memory controller 110 and a nonvolatile memory 130. Similarly, the memory module 104 includes a memory controller 140 and a nonvolatile memory 160.

The nonvolatile memories 130 and 160 are main memories, and are composed of a flash memory, respectively. The nonvolatile memories 130 and 160 are composed of many physical blocks, respectively. The nonvolatile memories 130 and 160 have a user memory area of 512M bytes, respectively. In both of the nonvolatile memories 130 and 160, at least one physical block is used as a temporary block used to store data transferred from a buffer memory.

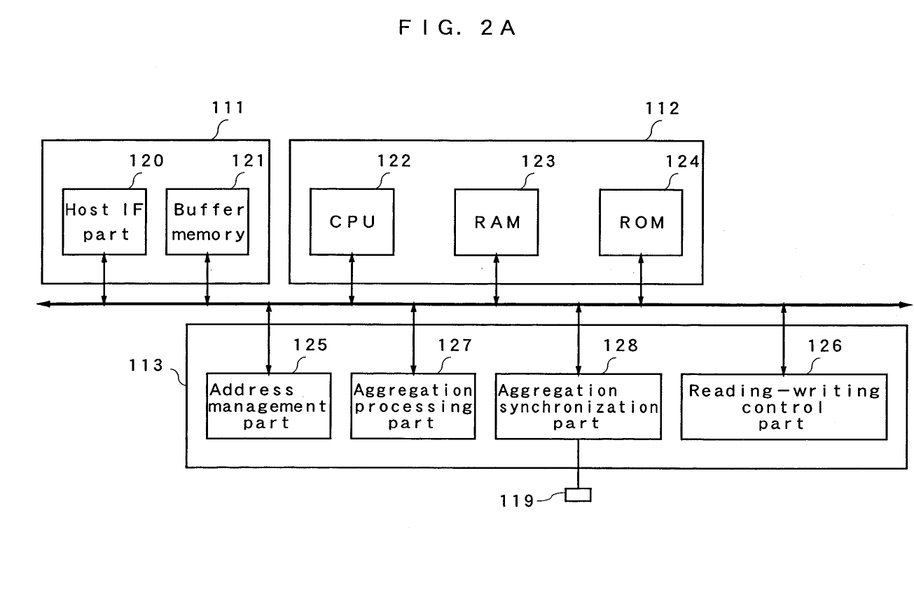

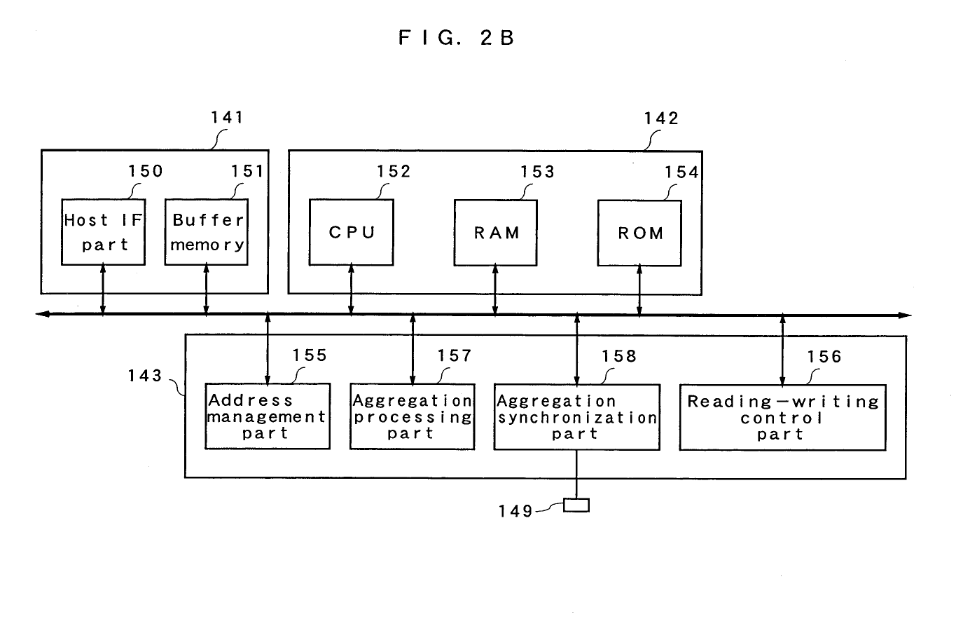

As shown in FIG. 1 and FIG. 2A, the memory controller 110 includes a front-end part 111, a core control part 112, a back-end part 113, a mode detection part 114, a master-slave detection part (hereinafter simply referred to as a MS detection part) 115, an A1 port 116, an A2 port 117, a B port 118, and a C port 119, and each of them is connected to an internal bus. Both of the A1 port 116 and the A2 port 117 are used for initialization. The B port 118 is used for communication between the memory controller 110 and the memory controller 140. As described below, the C port 119 is used to synchronize an aggregation process.

As shown in FIG. 1 and FIG. 2B, the memory controller 140 is same as the memory controller 110 and includes a front-end part 141, a core control part 142, a back-end part 143, a mode detection part 144, an MS detection part 145, an A1 port 146, an A2 port 147, a B port 148, and a C port 149, and each of them is connected to an internal bus. Both of the A1 port 146 and the A2 port 147 are used for initialization. The B port 148 is used for communication between the memory controller 140 and the memory controller 140. As described below, the C port 149 is used to synchronize an aggregation process.

The memory controllers 110 and 140 are driven in a single mode or a dual mode. In the single mode, only one of the memory controllers operates separately, and in the dual mode, the memory controller 110 and the memory controller 140 operate in parallel.

Next, since the memory controller 110 and the memory controller 140 have the same configuration, the memory controller 110 will be explained below in detail. The A1 port 116 and the A2 port 117 are used to receive a power supply voltage on a substrate as an identification signal. The B port 118 transfers a part of data temporarily retained in the buffer memory 121 to the memory module 104. Meanwhile, the power supply on the substrate is supplied from the access device 100.

The mode detection part 114 is a circuit block for determining the mode of operation, the single mode or the dual mode, on the basis of the identification signal inputted via the A1 port 116.

The MS determination part 115 is a circuit block for determining on the basis of the identification signal inputted via the A2 port 117 whether the memory controller 110 is used as a master controller or used as a slave controller.

Here, an operation mode corresponding to both values of a mode flag and a MS flag will be explained. When the mode flag represents the value 0, the single mode is employed regardless the value of the MS flag. For example, when the memory controller 110 is set to the single mode, only the memory module 103 operates as a memory device. Specifically, the nonvolatile memory device 101 serves as a memory device of 512 MB in the present embodiment. Meanwhile, In the case of the single mode, only one memory module is implemented to the nonvolatile memory device 101. On the other hand, in a case where the memory controllers 110 and 140 are set to be the dual mode, either one of the memories is set to be a master controller (MS flag=1), and the other memory is set to be the slave controller (MS=0). In this case, nonvolatile memories are implemented to both of the memory modules 103 and 104, which serve as a memory device of 1 G bytes in total.

As shown in FIG. 2A, the front-end part 111 includes a host interface (IF) part 120 and a buffer memory 121 for temporarily storing data when accessing the nonvolatile memory 130. Here, the buffer memory has a size of 16 k bytes.

The core control part 112 includes a CPU 122 for controlling whole of the memory controller 110, a RAM 123 which is a work region of the CPU 122, and a ROM 124 storing programs executed by the CPU 122.

The back-end part 113 includes an address management part 125, a reading-writing control part 126, an aggregation processing part 127, and an aggregation synchronization part 128. The address management part 125 designates an address of the nonvolatile memory 130. The reading-writing control part 126 controls a data writing to the nonvolatile memory 130 and a data reading from the nonvolatile memory 130. The address management part 125 internally includes: a logical-physical conversion table for converting a logical address transferred by the access device 100 into a physical address at the nonvolatile memory 130; and a physical region management table for storing statuses of the respective physical blocks constituting the nonvolatile memory 130. These are already in practical use and are realized by the circuit configuration same as the conventional circuit configuration, and accordingly an explanation thereof will be omitted.

The aggregation processing part 127 is a block for carrying out an aggregation process. The aggregation process is for rearranging data stored in physical blocks to be in a logical order when the access device 100 wrote data to logical addresses randomly. The aggregation synchronization part 128 orders the aggregation processing part 127 to carry out the aggregation when all free regions of temporary block in the nonvolatile memory 130 have run out, and outputs a synchronization signal to the other memory controller 140. Further, the aggregation synchronization part 128 orders the aggregation processing part 127 to carry out the aggregation also when a synchronization signal is given from an outside device, and makes the memory controllers 110 and 140 synchronously carry out the aggregation process.

As shown in FIG. 2B, the memory module 104 also includes a front-end part 141, a core control part 142, a back-end part 143, a mode detection part 144, an MS detection part 145, and the like, and has the same basic configuration as that of the memory module 103. FIG. 2B is a block diagram showing details of the front-end part 141, the core control part 142, and the back-end part 143. The front-end part 141 includes a host interface (IF) part 150 and a buffer memory 151 for temporarily storing data when the access device accesses the nonvolatile memory 160. Here, the buffer memory 151 has a size of 16 k bytes.

The core control part 142 includes a CPU 152 for controlling whole of the memory controller 140, a RAM 153 which is a work region of the CPU 152, and a ROM 154 for storing programs executed by the CPU 152.

The back-end part 143 includes an address management part 155, a reading-writing control part 156, an aggregation processing part 157, and an aggregation synchronization part 158. These components are the same as those of the memory module 103, and accordingly explanations thereof will be omitted. An explanation of operation described below will explain the differences in detail.

Next, an initialization process of the nonvolatile memory device 101 and an operation of a case where a writing command is issued from the access device 100 will be explained.

### Initialization Process at Power-On

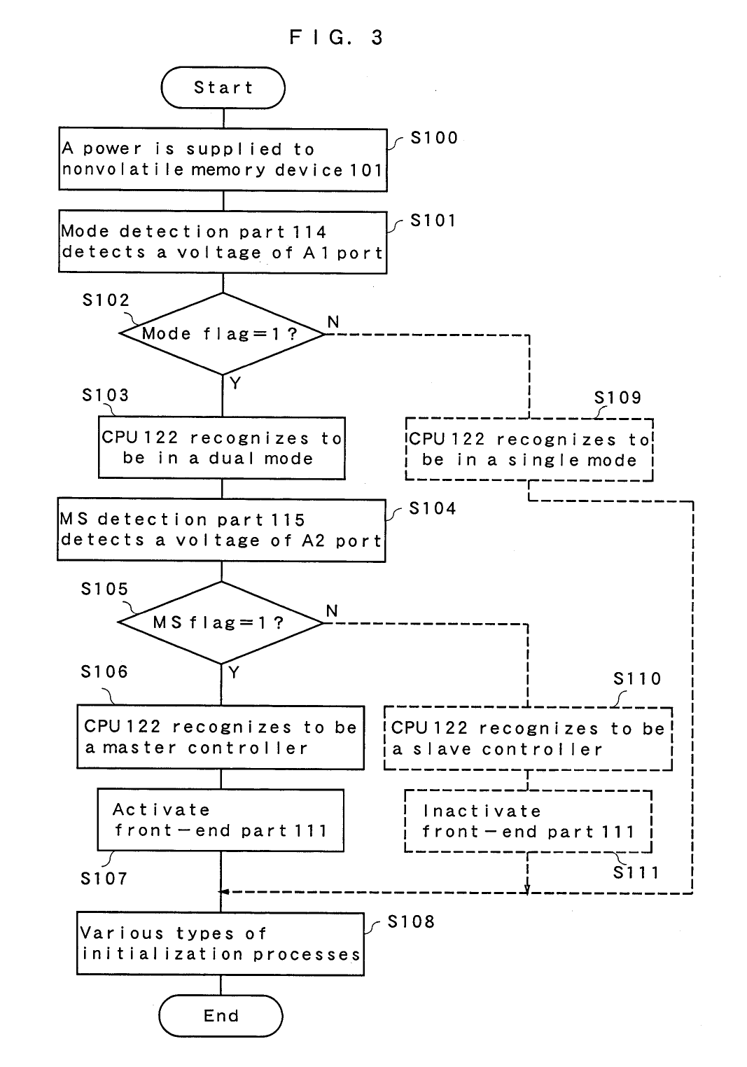

FIG. 3 is a flowchart showing the initialization process of the memory controller 110. A process shown by solid lines in FIG. 3 corresponds to a case shown in FIG. 1, namely, a process of a case where a power supply voltage (hereinafter referred to as Vcc) is set to the A1 port 116 and the A2 port 117. Meanwhile, a process shown by broken lines in FIG. 3 corresponds to a case where the GND is set to the A1 port 116 and the A2 port 117.

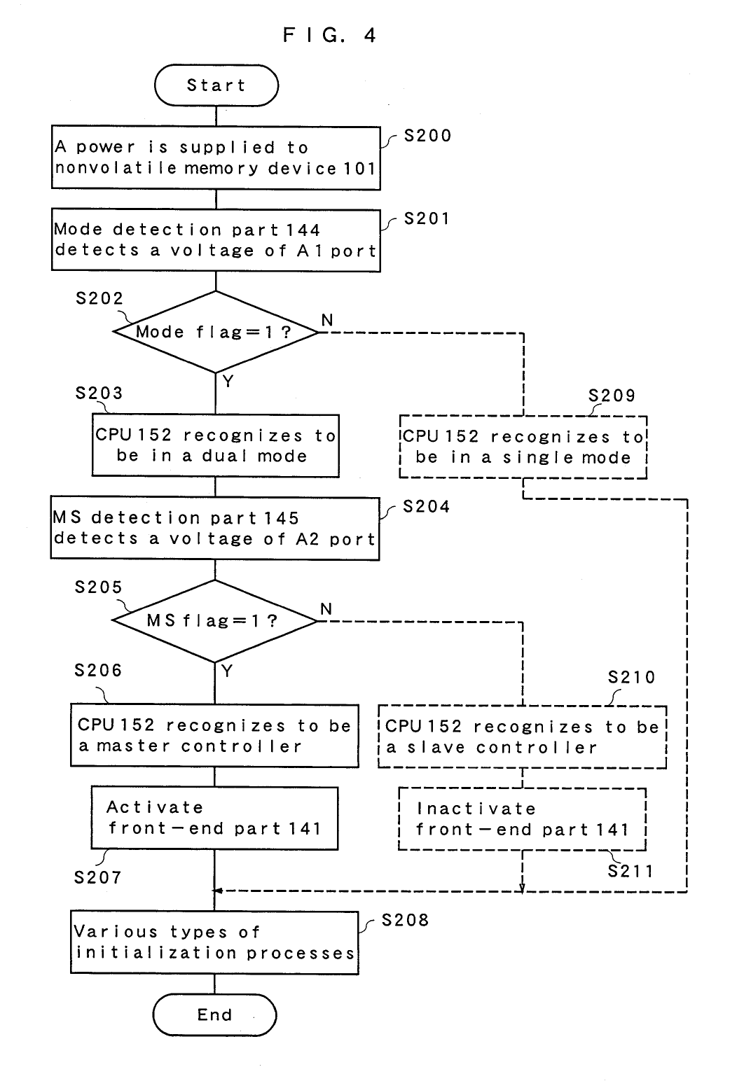

Meanwhile, FIG. 4 is a flowchart showing the initialization process of the memory controller 140. A process shown by solid lines in FIG. 4 corresponds to a case shown in FIG. 1, namely, a process of a case where the Vcc is set to the A1 port 146 and a ground voltage (hereinafter referred to as the GND) is set to the A2 port 147. In addition, a process shown by broken lines corresponds to a case where the GND is set to the A1 port 116 and the Vcc is set to the A2 port 117.

The memory controller 110 carries out the initialization process in accordance with the flowchart shown in FIG. 3. At first, after the access device 100 supplied a power supply to the nonvolatile memory device 101 (S100), the mode detection part 114 detects a voltage of the A1 port 116 (S101). In FIG. 1, since the Vcc is applied to the A1 port 116, the mode detection part 114 sets a mode flag to be a value 1 (S102), and transfers the mode flag (value 1) to the CPU 122. The CPU 122 recognizes being in the dual mode (S103).

Next, the MS detection part 115 detects a voltage of the A2 port 117 (S104). Since the Vcc is applied to the A2 port 117 in FIG. 1, the MS detection part 115 sets an MS flag to be a value 1 (S105), and transfers the MS flag (value 1) to the CPU 122. In this manner, the CPU 122 recognizes being a master controller (S106). The master controller exclusively manages the interface with the access device 100, and accordingly activates the front-end part 111 (S107).

After that, the process finishes after various types of initialization processes which are commonly carried out in a conventional nonvolatile memory system (creation of the logical-physical conversion table and the like). Meanwhile, explanations of the various types of initialization processes will be omitted.

As shown in FIG. 4, the memory controller 140 carries out an initialization process in parallel with the initialization process of the memory controller 110. Unlike the memory controller 110, the memory controller 140 is set as the slave controller by the process at S210 since the A2 port 147 is set to be the GND. In this case, since the front-end part 111 of the memory controller 110 exclusively carries out a communication process with the access device 100, a function of the front-end part 141 is inactivated. Meanwhile, the memory controller 140 receives necessary information such as information for the writing to the nonvolatile memory 160 via the B port 148.

### Process at Normal Operation

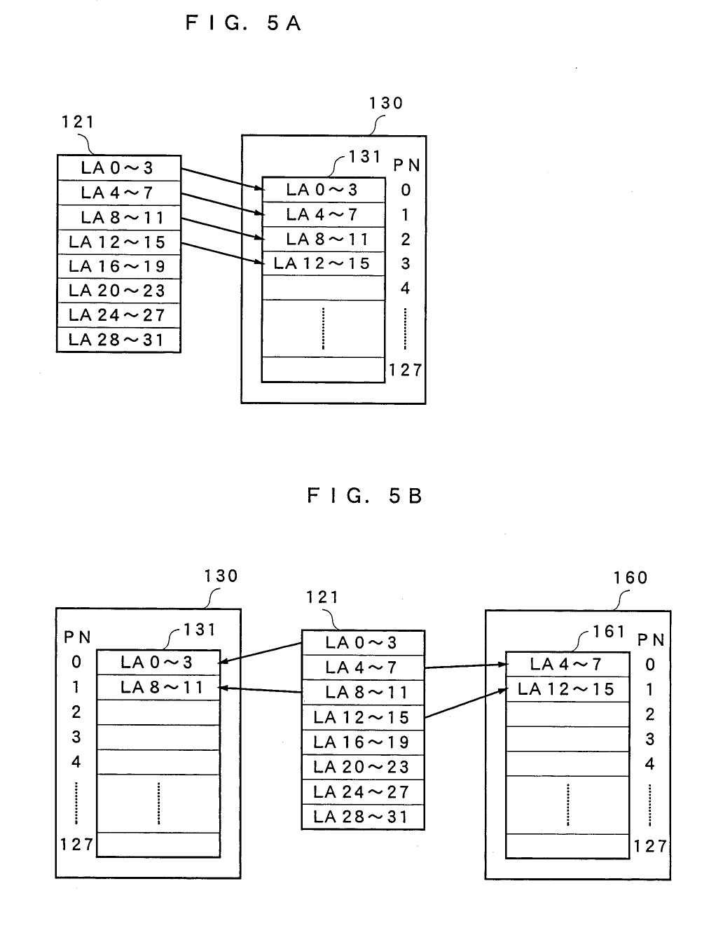

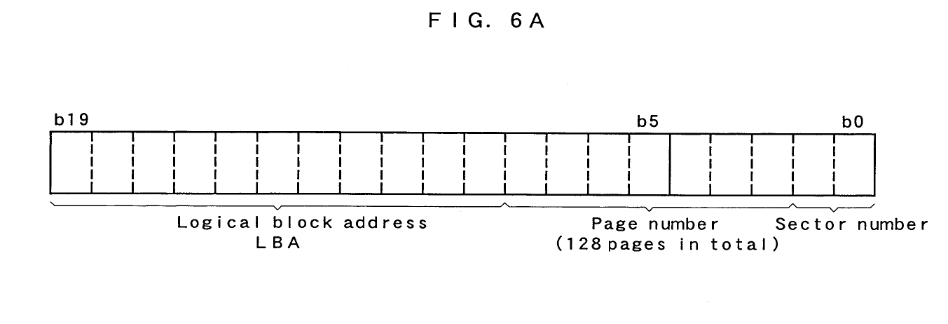

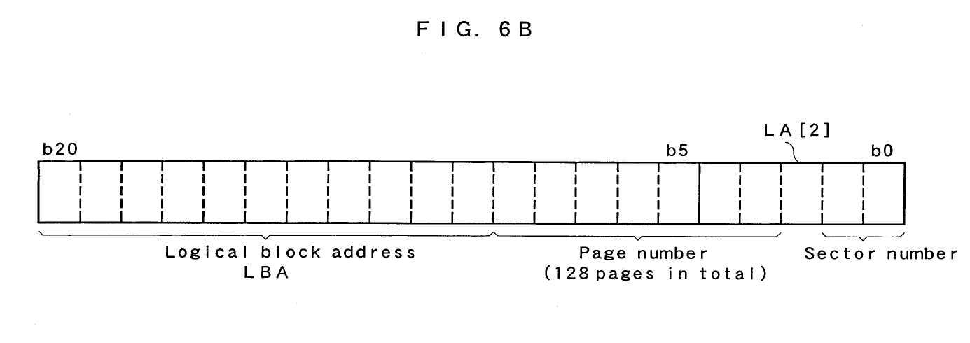

After the above-mentioned initialization process, the flow proceeds to a normal operation. FIG. 5A shows a writing process in the single mode, and FIG. 6A shows a format of a logical address LA in the single mode. As shown in FIG. 6A, in the logical address LA, a sector number, a page number, and a logical block address LBA are allocated in the order from the least significant bit. 11 bits corresponding to the logical block address LBA is a target of the address conversion, namely, corresponds to an address of the logical-physical conversion table. A sector size defined by the access device 100 is 512 bytes, and each page of the physical block 131 constituting the nonvolatile memory 130 stores 4 sectors as shown in FIG. 5A.

Meanwhile, FIG. 5B shows a writing process in the dual mode, and FIG. 6B shows a format of logical address LA in the dual mode. An MS setting flag added to the bit 2 of the logical address (hereinafter referred to as LA[2]) is different from the format of logical address LA in the single mode.

In FIG. 5A and FIG. 5B, it is assumed that the physical block 131 in the nonvolatile memory 130 is used as a temporary block used to store data transferred from the access device 100. Similarly, in the nonvolatile memory 160 of the memory module 104, a physical block 161 is used as the temporary block used to store data transferred from the access device 100. Other erased blocks are abbreviated in the drawings.

In the single mode, when the access device 100 issues a writing command for 16 k bytes corresponding to LA0 to LA31 for example, writing data is written to the physical block 131 serving as the temporary block via the buffer memory 121 in the order from the first page as shown in FIG. 5A.

In the dual mode, namely, when the initialization setting has been carried out in the state shown in FIG. 1, a control for changing a writing target is carried out in accordance with a value of LA[2] of the logical address format shown in FIG. 6B. In a case where LA[2] is 0, the memory controller 110 writes data temporarily stored by the buffer memory 121 to the physical block 131 of the nonvolatile memory 130, and in a case where LA[2] is 1, the memory controller transfers the data temporarily-stored in the buffer memory 121 to an internal bus of the memory controller 140 via the B ports 118 and 148. The transferred data is written to the physical block 161 serving as the temporary block via the reading-writing control part 156. The CPU 122 checks LA[2] of LA0 to LA31 transferred by the access device 100 one after another to carry out a data-allocating control in this manner.

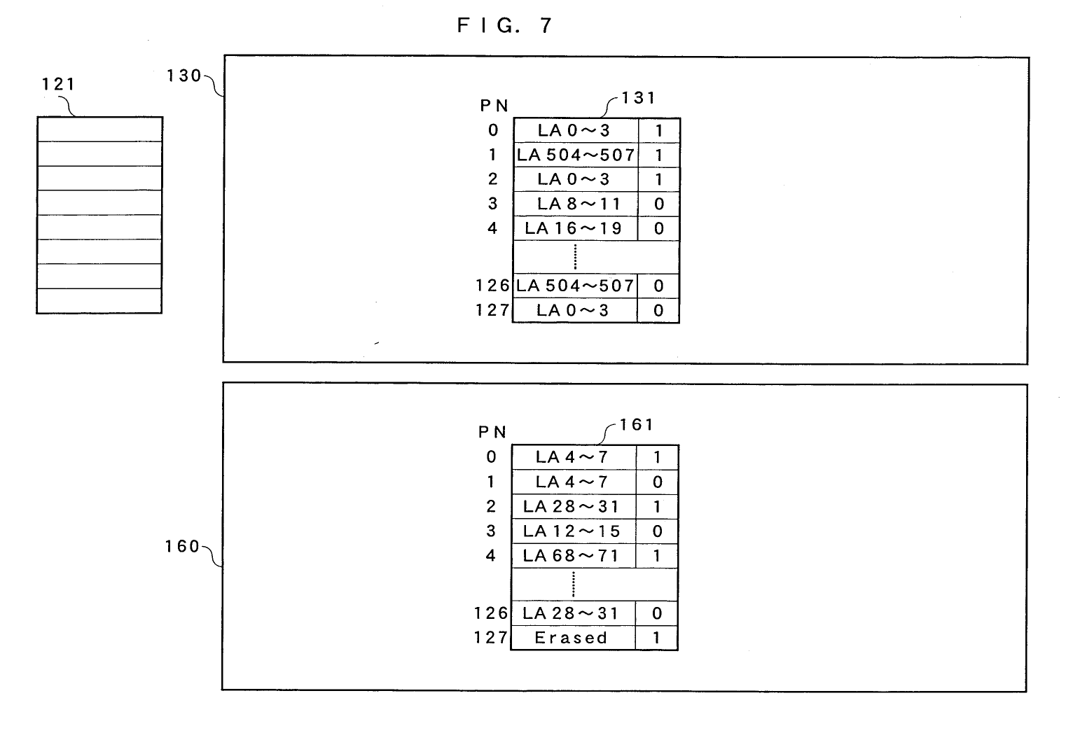

Then, it is assumed that the data writing is continued and data are randomly written to LA0 to LA3, LA504 to LA507, LA0 to LA3, LA8 to LA11, and so on in an ascending order from page PN0 to the last page PN127 of the physical block 131 as shown in FIG. 7. Here, the writing order to the pages is an ascending order from page PN0. Accordingly, though LA0 to LA3 are written in a plurality of pages in the physical block 131, for example, the lastly-written data are valid. Specifically, LA0 to LA3 written to page PN127 are valid here, and LA0 to LA3 written to page PN0 and page PN2 are invalid. The address management part 125 manages the data by writing a flag (0 indicates valid data and 1 indicates invalid data) to a corresponding management region after writing data to a data region via the reading-writing control part 126. The address management part 125 also manages which page data of some logical address is written to. In addition, data are randomly written in the physical block 161 such as LA4 to LA7, LA4 to LA7, . . . , LA28 to LA31 in an ascending order from page PN0 to page PN126. Page PN 127 is already erased.

A plurality of physical blocks may be used as the temporary blocks for each memory module, however, only the physical block 131 is used as the temporary block in the memory module 103. In the similar manner, only the physical block 161 is used as the temporary block in the memory module 104. Upon running out of all erased pages of the physical block 131, valid data in the physical block 131 are re-stored to another erased physical block in a logical address order. This process is called an aggregation process, which is a common technique applied to a conventional nonvolatile memory system.

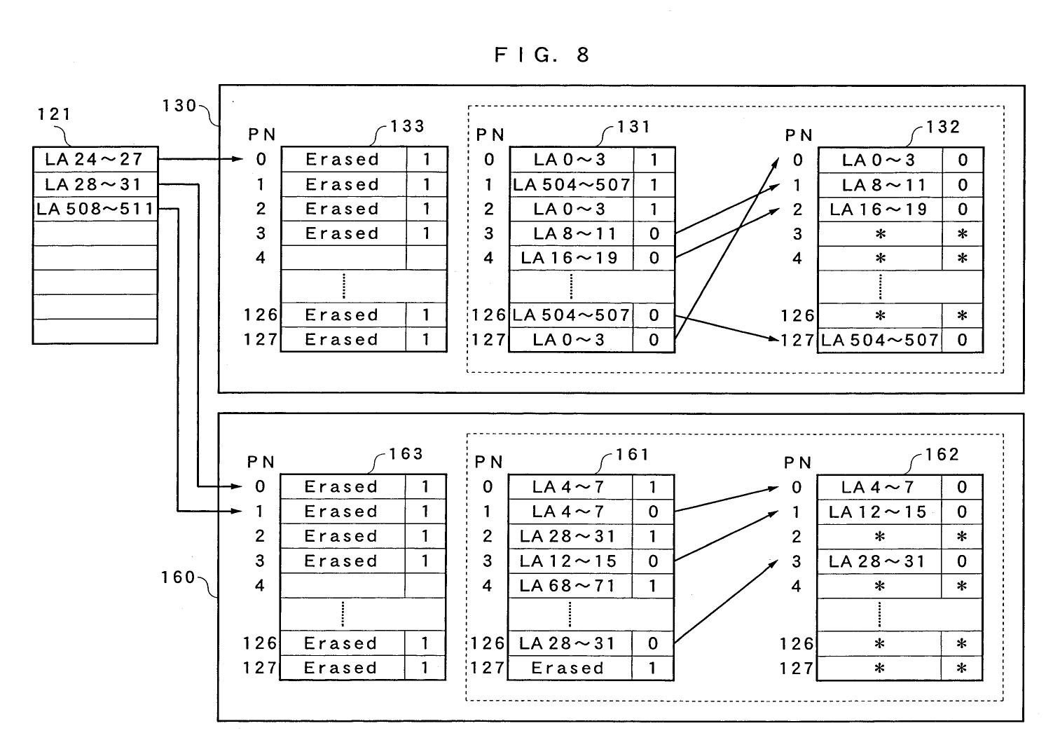

In a state where data have been written up to page PN127 of the physical block 131, data corresponding to LA24 to LA27, LA28 to LA31, and LA508 to LA511 is further transferred from the access device 100 to the buffer memory 121 as shown in FIG. 8. The memory controller 110 writes the data corresponding to LA24 to LA27 to the nonvolatile memory 130, and transfers the data corresponding to LA28 to LA31 and LA508 to LA511 to the memory controller 140.

The aggregation synchronization part 128 recognizes that data have been written up to page PN127 of the physical block 131, and orders the aggregation processing part 127 the aggregation process. Then, the aggregation synchronization part 128 transfers a synchronization signal to the port C 149 via the port C 119. The address management part 125 obtains erased physical blocks 132 and 133. The aggregation processing part 127 carries out the aggregation process via the reading-writing control part 126 so as to transfer data of the physical block 131 to the erased physical block 132 as shown in FIG. 8 by a broken line. After that, the address management part 125 registers the physical block 132 as a physical block corresponding to LA0 to LA511 to the logical physical conversion table. Moreover, the address management part 125 writes data corresponding to LA24 to LA27 retained by the buffer 121 to page PN0 of the new physical block 133 via the reading-writing control part 126, and erases the data in physical block 131. In addition, pages shown by a symbol “*” in the physical block 132 that is a aggregation destination are aggregated to the physical block 132 when corresponding valid data is stored in the physical block 131 and are not aggregated to the physical block 132 when corresponding valid data is not stored in the physical block 131.

Meanwhile, in the memory controller 140, the aggregation synchronization part 158 orders the aggregation processing part 157 the aggregation process. Though data is written up to page PN126 and an erased page PN127 remains in the physical block 161, the aggregation process is carried out even in this case and the aggregation processing part 157 aggregates only valid data of the physical block 161 to another physical block 162. Then, the memory controller 140 writes data corresponding to LA28 to LA31 and LA508 to LA511 transferred from the master memory controller 110 to a new physical block 163.

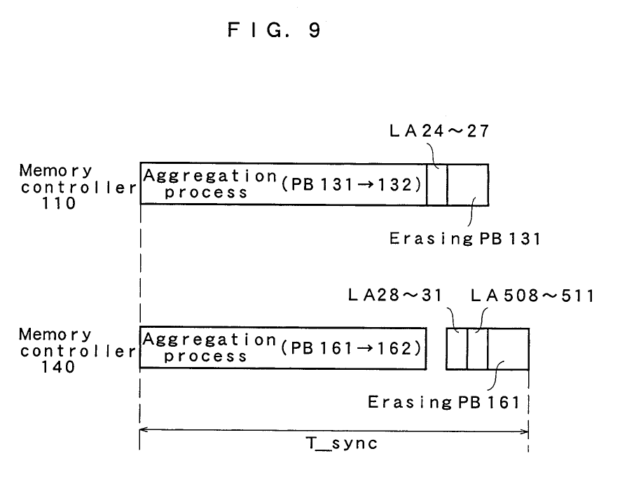

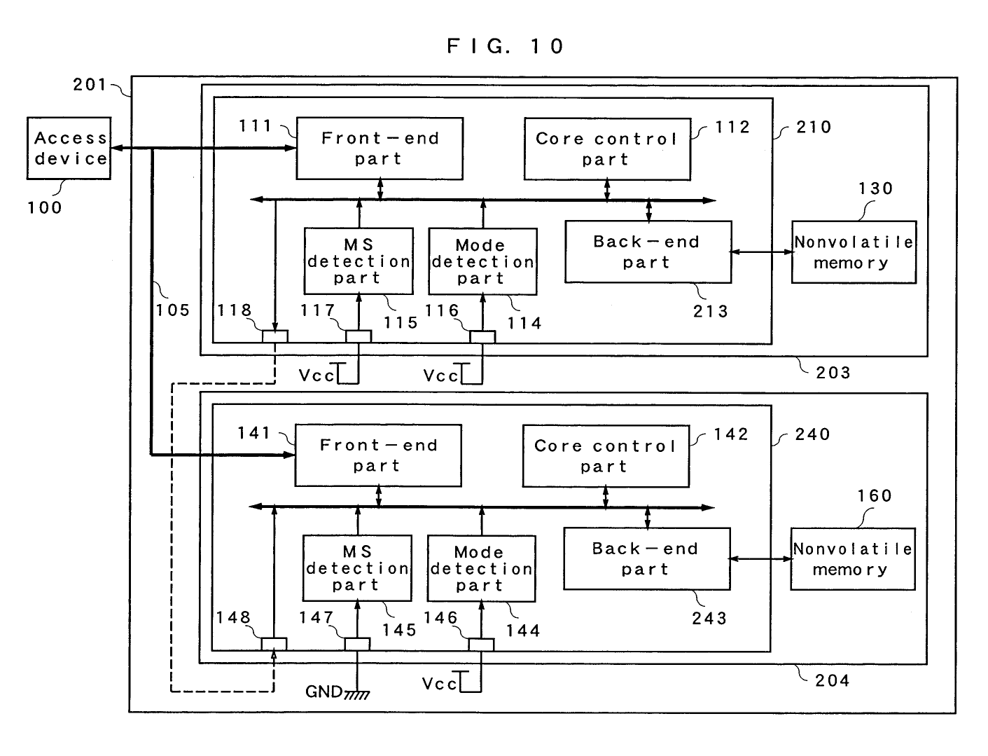

FIG. 9 shows this process on a temporal axis, and time required in a series of the process is shown by T_sync. As shown in FIG. 9, the aggregation process of one memory controller and the aggregation process of the other memory controller are simultaneously carried out in parallel. Here, the memory controller 140 starts the aggregation process with the aggregation of the memory controller 110. Meanwhile, when all pages of the physical block 161 store data and it is required to further write data to this block, the memory controller 140 starts the aggregation process and issues a synchronization signal thereof to the memory controller 110. Accordingly, the memory controller 110 simultaneously carries out the aggregation.

As described above, since the present embodiment has two memory modules each including a nonvolatile memory and memory controller, and when one memory controller carries out the aggregation process, the other memory controller simultaneously carries out the aggregation process, the present embodiment is able to shorten the process time T_sync related to the aggregation process as shown in FIG. 9 and accordingly an overall writing speed of the nonvolatile memory system can be increased.

In addition, according to the present embodiment, since the mode detection part 114 and the MS detection part 115 are able to recognize in the initialization process at power-on whether the controller is a master controller or a slave controller on the basis of a voltage such as the Vcc or the GND, and further the memory controller recognized as the master controller, namely, the front-end part 111 of the memory controller 110 exclusively communicates with the access device 100 and a nonvolatile memory of writing destination is allocated in accordance with a logical address, data can be easily written to different nonvolatile memories in parallel by using a common memory controller.

### Comparative Example

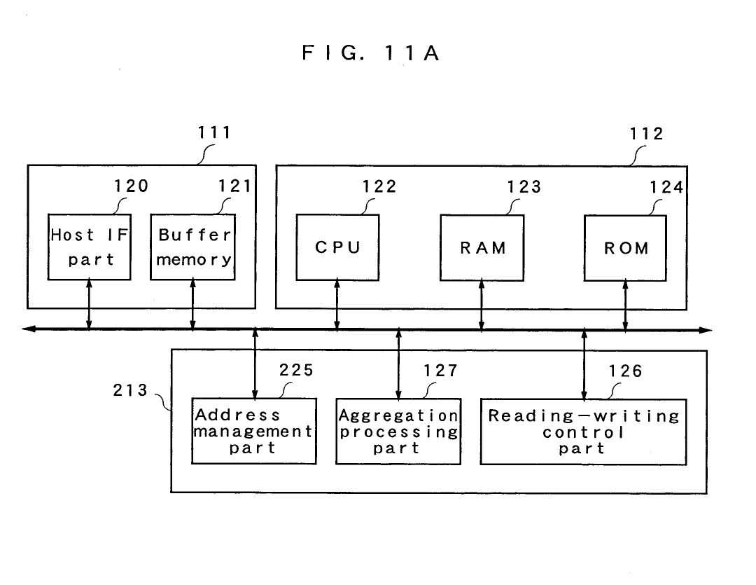

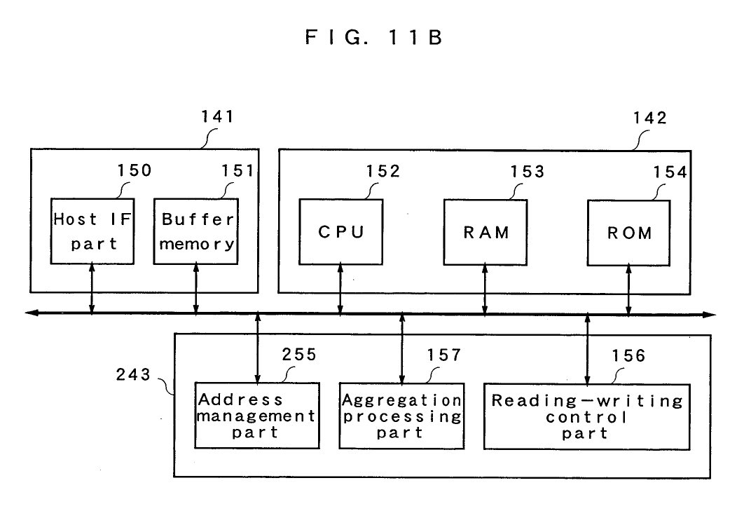

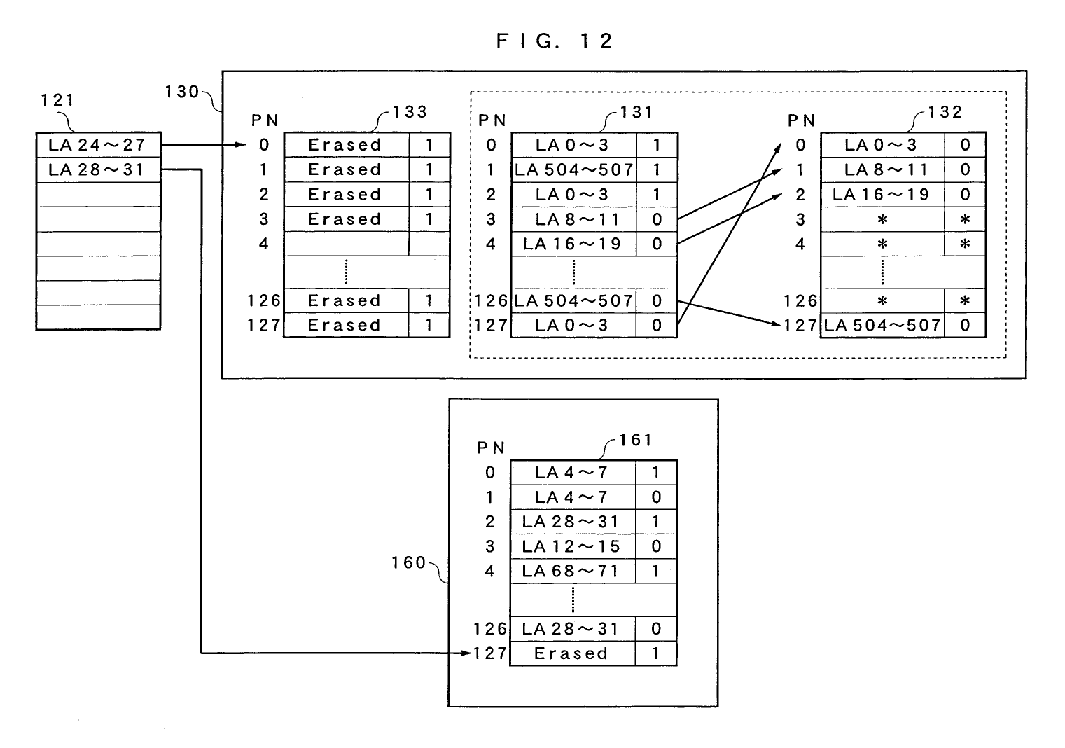

Next, referring to FIG. 10, FIG. 11A, and FIG. 11B, a nonvolatile memory system according to a comparative example will be explained. In these drawings, the same numerals are added to the same components. The nonvolatile memory device 201 has two memory modules 203 and 204. Back-end parts of the memory modules 203 and 204 are different from that of the embodiment, and are called a back-end part 213 and a back-end part 243, respectively. Unlike the embodiment, the back-end parts 213 and 243 do not have the aggregation synchronization part as shown in FIG. 11A and FIG. 11B, and additionally an address management part 225 is different from an address management part 255. Since the comparative example does not have the aggregation synchronization part, aggregation processes of the two memory module are not simultaneously carried out.

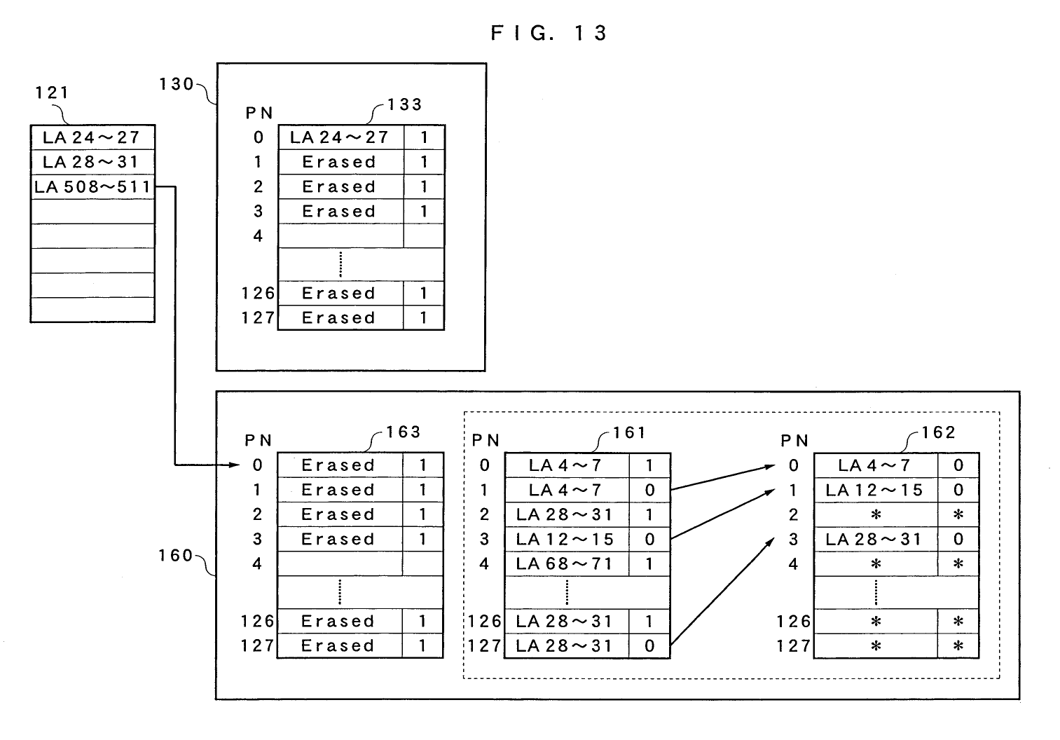

Next, referring to FIG. 12 to FIG. 14, a writing process in the comparative example will be explained. Also in the comparative example, the memory controller 210 serves as the master controller and the memory controller 240 serves as the slave controller, and the controllers operate in the dual mode. In FIG. 12, it is assumed that the physical block 131 in the nonvolatile memory 130 is used as a temporary block for retaining data sent for the access device 100. Data are randomly written to LA0 to LA3, LA504 to LA507, LA0 to LA3, LA8 to LA11, and so on in an ascending order from page PN0 to the last page PN127 of the physical block 131.

In this state, the access device 100 further sends data corresponding to LA24 to LA27 and LA28 to LA31 to the buffer memory 121. The memory controller 210 writes data corresponding to LA24 to LA27 and transfers data corresponding to LA28 to LA31 to the memory controller 240.

The address management part 225 recognizes that data have been written up to page PN127 of the physical block 131, and orders the aggregation processing part 127 the aggregation process and obtains erased physical blocks 132 and 133. The aggregation processing part 127 carries out a process for aggregating data of the physical block 131 to the erased physical block 132 via the reading-writing control part 126 as shown in a broken line. After that, the address management part 225 registers the physical block 132 as a physical block corresponding to logical blocks LA0 to LA511 to the logical physical conversion table. Moreover, the address management part 225 writes data corresponding to LA24 to LA27 to page PN0 of the physical block 133 via the reading-writing control part 126, and erases the physical block 131.

Meanwhile, the memory controller 240 writes data corresponding to LA28 to LA31 to the nonvolatile memory 160, however, since the physical block 161 that is a temporary block only stores data up to page PN126, namely, page PN 127 is an erased page, the address management part 255 writes data corresponding to LA28 to LA31 to page PN127 of the physical block 161 via the reading-writing control part 156.

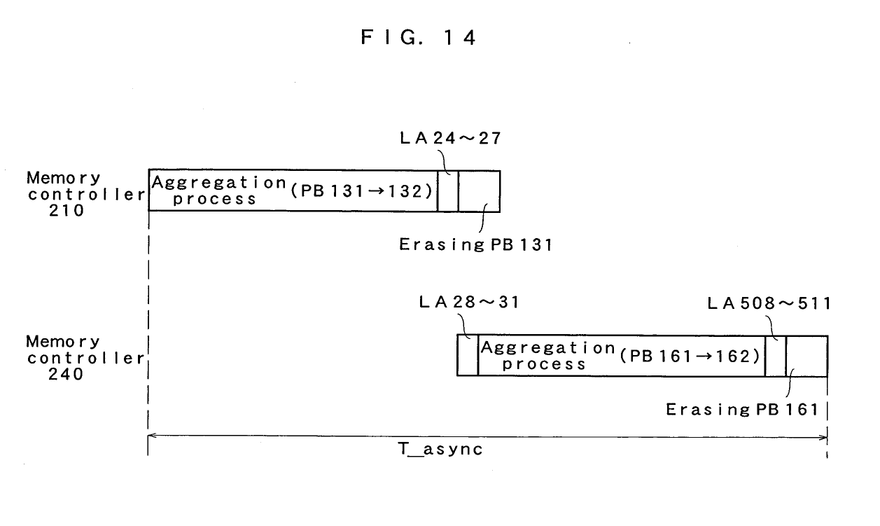

Next, when the access device 100 sends data corresponding to LA508 to LA511 to the nonvolatile memory device as shown in FIG. 13, th memory controller 210 transfers the data corresponding to LA508 to LA511 temporarily retained by the buffer memory 121 to the memory controller 240.

The address management part 255 recognizes that data have been written up to page PN127 of the physical block 161, and orders the aggregation processing part 157 the aggregation process and obtains erased physical blocks 162 and 163. The aggregation processing part 157 carries out a process for aggregating data of the physical block 161 to the erased physical block 162 via the reading-writing control part 156. After that, the address management part 255 registers the physical block 162 as a physical block corresponding to LA0 to LA511 to the logical physical conversion table. Moreover, the address management part 255 writes data corresponding to LA508 to LA511 to page PN0 of the erased physical block 163 via the reading-writing control part 156, and erases the physical block 161. FIG. 14 shows the above-mentioned process on a temporal axis, and time required in a series of the process is shown by T_async.

In this comparative example, the aggregation process is carried out in each memory controller after all data were written to the respective temporary blocks. A total time required for the aggregation process accordingly becomes longer than that of the present embodiment. On the other hand, in the present embodiment, since being simultaneously carried out, the aggregation processes are covered up each other. Specifically, T_sync becomes shorter than T_async, resulting in increase of an overall writing speed of the nonvolatile memory system.

Meanwhile, when running out of all free regions of a temporary block in the nonvolatile memories 130 or 160 for storing data transferred from the buffer memory 121 or a synchronization signal has been given from an outside device, both of the aggregation synchronization parts 128 and 158 order the aggregation processing parts 127 and 157 the aggregation, however, the aggregation synchronization parts 128 and 158 may order the aggregation processing parts 127 and 157 the aggregation when a free capacity of the temporary block falls below a predetermined threshold value.

In addition, in the above-mentioned embodiment of the present invention, the case of using two memory modules has been explained, however, the present invention is not limited to this case and can be configured by employing three or more memory modules. In that case, one of the controllers is used as a master controller and the other memory controllers are used as slave controllers.

### INDUSTRIAL APPLICABILITY

In a device employing a nonvolatile memory such as a flash memory, a memory controller, a nonvolatile memory device, and a nonvolatile memory system according to the present invention are able to shorten time for an aggregation process, improve a writing speed, and be widely used as a memory medium of: a potable AV apparatus such as still image recording and reproducing device and a moving image recording-reproducing device; and a portable communication apparatus such as a mobile phone.

1. A memory controller which writes data to a nonvolatile memory having a plurality of physical blocks as a recording area and reads data from said nonvolatile memory, comprising:
a reading-writing control part for carrying out data writing and data reading processes to said nonvolatile memory in accordance with a signal from an outside device;
an aggregation synchronization part for ordering starting an aggregation process when all free regions of a temporary physical block to which transferred data is temporarily written have run out or when a synchronization signal is inputted from the outside device, and for outputting a synchronization signal when all free regions of said temporary physical block have run out; and
an aggregation processing part for aggregating valid data of said temporary physical block to another physical block on the basis of a signal from said aggregation synchronization part.

2. The memory controller according to claim 1, further comprising:
a mode detection part for determining based on an identification signal inputted from the outside device whether the memory controller is activated in a single mode or in a dual mode.

3. The memory controller according to claim 1, further comprising:
a master-slave detection part for determining based on an identification signal inputted from the outside device whether the memory controller is used as a master memory controller or a slave memory controller.

4. The memory controller according to claim 1, further comprising:
a mode detection part for determining based on an identification signal inputted from the outside device whether the memory controller is activated in a single mode or in a dual mode; and
a master-slave detection part for determining based on the identification signal inputted from the outside device whether the memory controller is used as a master memory controller or a slave memory controller.

5. A memory controller comprising:
a reading-writing control part for carrying out data writing and data reading processes to said nonvolatile memory in accordance with a signal from an outside device;
an aggregation synchronization part for ordering starting an aggregation process when a free capacity of a temporary physical block have fallen below a predetermined threshold value or when a synchronization signal is inputted from the outside device, and for outputting a synchronization signal when a free capacity of said temporary physical block have fallen below the predetermined threshold value; and
an aggregation processing part for aggregating valid data of said temporary physical block to another physical block on the basis of a signal from said aggregation synchronization part.

6. A nonvolatile memory device having a plurality of memory modules, wherein
said each memory module includes:
a nonvolatile memory having a plurality of physical blocks as a recording area; and
a memory controller for writing data to said nonvolatile memory and reading data from said nonvolatile memory, and
said memory controller includes:
a reading-writing control part for carrying out data writing and data reading processes to said nonvolatile memory in accordance with a signal from an outside device;
an aggregation synchronization part for ordering starting an aggregation process when all free regions of a temporary physical block to which transferred data is temporarily written have run out or when a synchronization signal is inputted from a memory controller of another memory module, and for outputting a synchronization signal when all free regions of said temporary physical block have run out; and
an aggregation processing part for aggregating valid data of said temporary physical block to another physical block on the basis of a signal from said aggregation synchronization part.

7. The nonvolatile memory device according to claim 6, wherein
said each memory controller further includes:
a mode detection part for determining based on an identification signal inputted from the outside device whether the memory controller is activated in a single mode or in a dual mode.

8. The nonvolatile memory device according to claim 6, wherein
said each memory controller further includes:
a master-slave detection part for determining based on an identification signal inputted from the outside device whether the each memory controller is used as a master memory controller or a slave memory controller.

9. The nonvolatile memory device according to claim 8, wherein
based on a signal from a master-slave detection part of one memory module, said master-slave detection part uses other memory controller as the master memory controller or the slave memory controller.

10. The nonvolatile memory device according to claim 6, wherein
said each memory controller further includes:
a mode detection part for determining based on an identification signal inputted from the outside device whether the each memory controller is activated in a single mode or in a dual mode; and
a master-slave detection part for determining based on the identification signal inputted from the outside device whether the each memory controller is used as a master memory controller or a slave memory controller.

11. The nonvolatile memory device according to claim 10, wherein
based on a signal from a master-slave detection part of one memory module, said master-slave detection part uses other memory controller as the master memory controller or the slave memory controller.

12. A nonvolatile memory device having a plurality of memory modules, wherein
said each memory module includes:
a nonvolatile memory having a plurality of physical blocks as a recording area; and
a memory controller for writing data to said nonvolatile memory and reading data from said nonvolatile memory, and
said memory controller includes:
a reading-writing control part for carrying out data writing and data reading processes to said nonvolatile memory in accordance with a signal from an outside device;
an aggregation synchronization part for ordering starting an aggregation process when a free capacity of a temporary physical block have fallen below a predetermined threshold value or when a synchronization signal is inputted from a memory controller of another memory module, and for outputting a synchronization signal when a free capacity of said temporary physical block have fallen below the predetermined threshold value; and
an aggregation processing part for aggregating valid data of said temporary physical block to another physical block on the basis of a signal from said aggregation synchronization part.

13. A nonvolatile memory system comprising:
a nonvolatile memory device having a plurality of memory modules; and
an access device for accessing said nonvolatile memory device, wherein
each memory module is said nonvolatile memory device includes:
a nonvolatile memory having a plurality of physical blocks as a recording area; and
a memory controller for writing data to said nonvolatile memory and reading data from said nonvolatile memory, and
said memory controller includes:
a reading-writing control part for carrying out data writing and data reading processes to said nonvolatile memory in accordance with a signal from an outside device;
an aggregation synchronization part for ordering starting an aggregation process when all free regions of a temporary physical block to which transferred data is temporarily written have run out or when a synchronization signal is inputted from a memory controller of another memory module, and for outputting a synchronization signal when all free regions of said temporary physical block have run out; and
an aggregation processing part for aggregating valid data of said temporary physical block to another physical block on the basis of a signal from said aggregation synchronization part.

14. The nonvolatile memory system according to claim 13, wherein
said each memory controller further includes:
a mode detection part for determining based on an identification signal inputted from the outside device whether the memory controller is activated in a single mode or in a dual mode.

15. The nonvolatile memory system according to claim 13, wherein
said each memory controller further includes:
a master-slave detection part for determining based on an identification signal inputted from the outside device whether the each memory controller is used as a master memory controller or a slave memory controller.

16. The nonvolatile memory system according to claim 15, wherein
based on a signal from a master-slave detection part of one memory module, said master-slave detection part uses other memory controller as the master memory controller or the slave memory controller.

17. The nonvolatile memory system according to claim 13, wherein
said each memory controller further includes:
a mode detection part for determining based on an identification signal inputted from the outside device whether the each memory controller is activated in a single mode or in a dual mode; and
a master-slave detection part for determining based on the identification signal inputted from the outside device whether the each memory controller is used as a master memory controller or a slave memory controller.

18. The nonvolatile memory system according to claim 17, wherein
based on a signal from a master-slave detection part of one memory module, said master-slave detection part uses other memory controller as the master memory controller or the slave memory controller.

19. A nonvolatile memory system comprising:
a nonvolatile memory device having a plurality of memory modules; and
an access device for accessing said nonvolatile memory device, wherein
each memory module is said nonvolatile memory device includes:
a nonvolatile memory having a plurality of physical blocks as a recording area; and
a memory controller for writing data to said nonvolatile memory and reading data from said nonvolatile memory, and
said memory controller includes:
a reading-writing control part for carrying out data writing and data reading processes to said nonvolatile memory in accordance with a signal from an outside device;
an aggregation synchronization part for ordering starting an aggregation process when a free capacity of a temporary physical block have fallen below a predetermined threshold value or when a synchronization signal is inputted from a memory controller of another memory module, and for outputting a synchronization signal when a free capacity of said temporary physical block have fallen below the predetermined threshold value; and
an aggregation processing part for aggregating valid data of said temporary physical block to another physical block on the basis of a signal from said aggregation synchronization part.
